(19) United States
(12) Patent Application Publication
(10) Pub. No.: US 2018/0169751 A1
(43) Pub. Date: Jun. 21, 2018

(54) THERMOMETRIC METALLURGY MATERIALS

(71) Applicants: FEDERAL-MOGUL LLC, Southfield, MI (US); LA CORPORATION DE L'ECOLE POLYTECHNIQUE DE MONTREAL, Montreat (CA)

(72) Inventors: Philippe BEAULIEU, Coventry (GB); Denis B. CHRISTOPHERSON, JR., Waupun, WI (US); Leslie John FARTHING, Rugby (GB); Gilles L'ESPERANCE, Waupun (CA); Olivier SIOUI-LATULIPPE, Saint-Hubert (CA)

(21) Appl. No.: 15/844,277

(22) Filed: Dec. 15, 2017

Related U.S. Application Data
(60) Provisional application No. 62/435,280, filed on Dec. 16, 2016.

(51) Int. Cl. B22F 1/00; G01N 3/40; G01N 25/18

(52) U.S. Cl. CPC B22F 1/0007; B22F 2301/35; G01N 25/18; G01N 3/40

(57) ABSTRACT

A thermometric powder metal material for testing to replicate an actual powder material during use of the actual powder metal material in an internal combustion engine is provided. The thermometric powder metal material includes pores and has a decrease in hardness as a function of temperature according to the following equation: D Hardness/D Temperature=>0.5 HV/° C. The properties of the actual powder metal material, when the actual powder metal is used in an internal combustion engine, can be estimated using the thermometric powder metal material by first adjusting the thermal conductivity of the thermometric powder metal material or controlling the porosity of the thermometric powder metal material to replicate the actual powder metal material, and then subjecting thermometric powder metal material to an engine test. For example, the thermal conductivity can be adjusted by infiltrating the thermometric powder metal material with copper.

### CROSS REFERENCE TO RELATED APPLICATION

This U.S. utility patent application claims priority to U.S. provisional patent application No. 62/435,280, filed Dec. 16, 2016, the contents of which is incorporated herein by reference in its entirety.

### BACKGROUND OF THE INVENTION

### 1. Field of the Invention

This invention relates generally to a thermometric material, more specifically a thermometric powder metal material, a method of manufacturing the thermometric powder metal material, and applications making use of the thermometric powder metal material.

### 2. Related Art

Powder metal materials are oftentimes used to form parts with improved wear resistance and/or thermal conductivity for automotive vehicle applications, such as valve guides and valve seat inserts. A typical exhaust valve seat insert can reach a temperature between 400° C. and 500° C. during engine operation. Due to the demanding environment of the engine, the materials used to form valve guides and valve seat inserts preferably have a high hot hardness. Recently, it has been more desirable to also provide valve seats inserts and guides having a high thermal conductivity. The materials should also provide sufficient wear resistance from a low temperature, such as at the start of the engine, to a high temperature, such as when the engine is operating at high performance and running at full rated powder. In addition to hardness and thermal conductivity, the porosity and density of the materials are also important characteristics.

The properties of the powder metal materials used in valve guides and valve seat inserts are typically tested prior to use of the materials in the internal combustion engines. It is important that the thermal conductivity of the powder metal materials tested accurately represent the thermal conductivity of the powder metal materials which will actually be produced and used in the internal combustion engine. However, the thermal conductivity of the powder metal materials tested can vary significantly because of the porous nature of the materials. Currently known wrought thermometric materials, such as EN19T or AISI 4140, have a fixed thermal conductivity and therefore, when such materials are tested, the temperature gradients of those materials may not be representative of the temperature gradients actually obtained when the wrought materials are used in valve seat inserts or valve guides of internal combustion engines.

### SUMMARY OF THE INVENTION

One aspect of the invention provides a thermometric powder metal material for testing to replicate an actual powder material during use of the actual powder metal material in an internal combustion engine. The thermometric powder metal material includes pores and has a decrease in hardness as a function of temperature according to the following equation: D Hardness/D Temperature=>0.5 HV/° C.

Another aspect of the invention provides a method of manufacturing a thermometric powder metal material for testing which replicates an actual powder metal material during use of the actual powder metal material in an internal combustion engine; and the method comprises adjusting the thermal conductivity of the thermometric powder metal material.

For example, the method of manufacturing the thermometric powder metal material used to estimate properties of the actual powder metal material when the powder metal material is used in an internal combustion engine can include adjusting the thermal conductivity of the thermometric powder metal material so that the thermal conductivity of the thermometric powder metal material simulates the thermal conductivity of the actual powder metal material during use of the actual powder metal material in the internal combustion engine. The thermal conductivity can be controlled or adjusted by controlling the porosity of the material and/or infiltrating the pores of the material with copper.

Another aspect of the invention provides a method of estimating properties of an actual powder metal material when the actual powder metal is used in an internal combustion engine using a thermometric powder metal material; and the method comprises adjusting the thermal conductivity of the thermometric powder metal material.

For example, the method of estimating properties, such as thermal conductivity and temperature, of the actual powder metal material in an internal combustion engine using the thermometric powder metal material can include adjusting the porosity and/or infiltrating the thermometric powder metal material with copper prior to testing, so that during the test procedure, the thermal conductivity of the thermometric powder metal material simulates the thermal conductivity of the actual powder metal material during use of the actual powder metal material in the internal combustion engine.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an example of a portion of an internal combustion engine including a valve seat insert formed of a thermometric powder metal material according to one embodiment of the invention;

FIG. 2A is theoretical illustration of change in hardness relative to change in tempering temperature for a thermometric powder metal material according to an example embodiment of the invention (example A) and four comparative powder metal materials (examples B-E);

FIG. 2B illustrates a change in hardness relative to change in tempering temperature for comparative materials (W1, O1, S1, A2, and M2);

FIG. 3 includes compositions of a standard wrought thermometric material (AISI 1541), and standard powder metal materials used in valve seat insert and valve guides (examples 1-5);

FIG. 4 is a graph illustrating thermal conductivity relative to temperature of the materials of FIG. 3;

FIG. 5 includes example thermometric powder metal material compositions;

FIG. 6 illustrates a change in hardness relative to change in temperature for one of the example thermometric powder metal material compositions of FIG. 5 and a comparative wrought material.

### DETAILS DESCRIPTION OF EXEMPLARY EMBODIMENTS

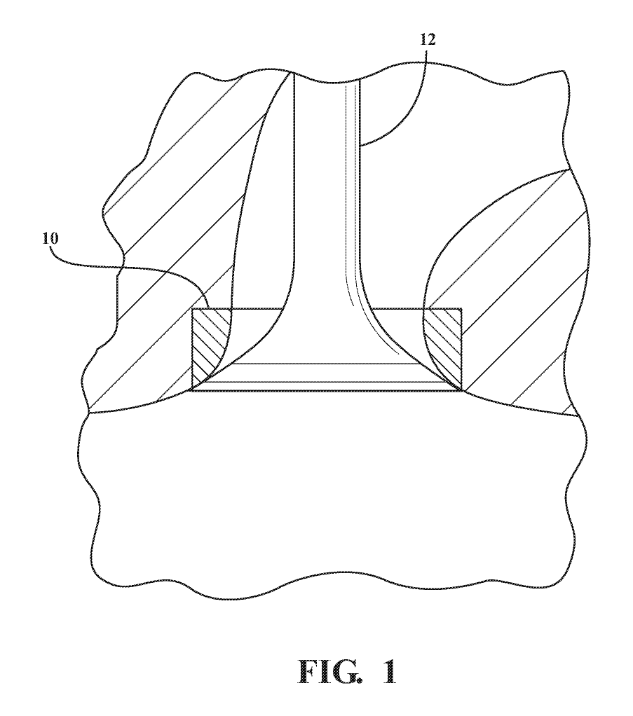

One aspect of the invention provides a thermometric powder metal material for testing to replicate an actual powder material under operating conditions of an internal combustion engine. According to one embodiment, the thermometric powder metal material is used to replicate a powder metal material used in a valve seat application or used to form a component of a valve seat application, for example to form a valve seat insert 10 surrounding a valve 12, as shown in FIG. 1. The thermometric powder metal material can also be used to replicate powder metal materials used in a valve guide or another component subject to the harsh conditions of an internal combustion engine. For example, the thermometric powder metal material can be used to replicate a powder metal material used in a valve seat insert or valve guide having a thermal conductivity of 10 to 100 W/mK.

The test thermometric powder metal material has a controlled or adjusted thermal conductivity replicating the thermal conductivity of the actual powder metal material produced during operation of the internal combustion engine. The thermometric powder metal material can also be tailored to replicate a variety of powder metal materials with different thermal conductivities. The temperature gradient of the test thermometric powder metal material is more accurate than other materials used for testing purposes. Accordingly, when the thermometric powder metal material is tested prior to use in the internal combustion engine, the material allows for a more accurate estimation of engine operating temperatures and provides a more accurate simulation of the engine conditions.

The thermal conductivity of powder metal materials can vary significantly due to the porous nature of the materials. According to one embodiment of the invention, to control or adjust the thermal conductivity of the test thermometric powder metal material and thus more accurately represent the thermal conductivity of the actual powder metal material in production and under the engine operating conditions, the pores of the test thermometric powder metal material are infiltrated with copper. The thermal conductivity can also be controlled or adjusted by controlling or adjusting the amount of porosity of the thermometric powder metal material in other manners. For example, the porosity can be controlled by the green density of the material, with or without the copper infiltration. The controlled porosity and/or copper infiltration contribute to the more accurate engine temperature estimations and the improved simulation of the actual engine conditions.

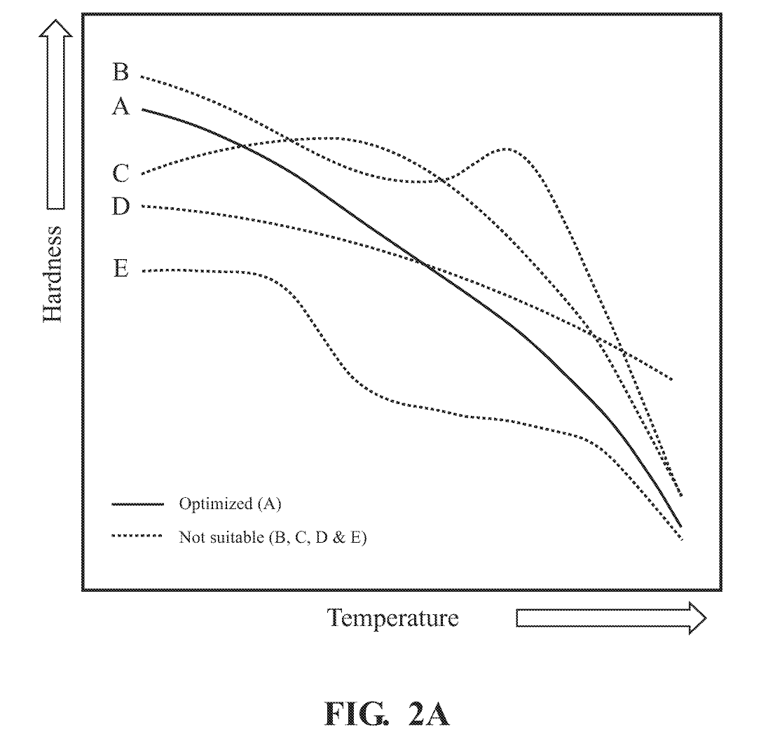

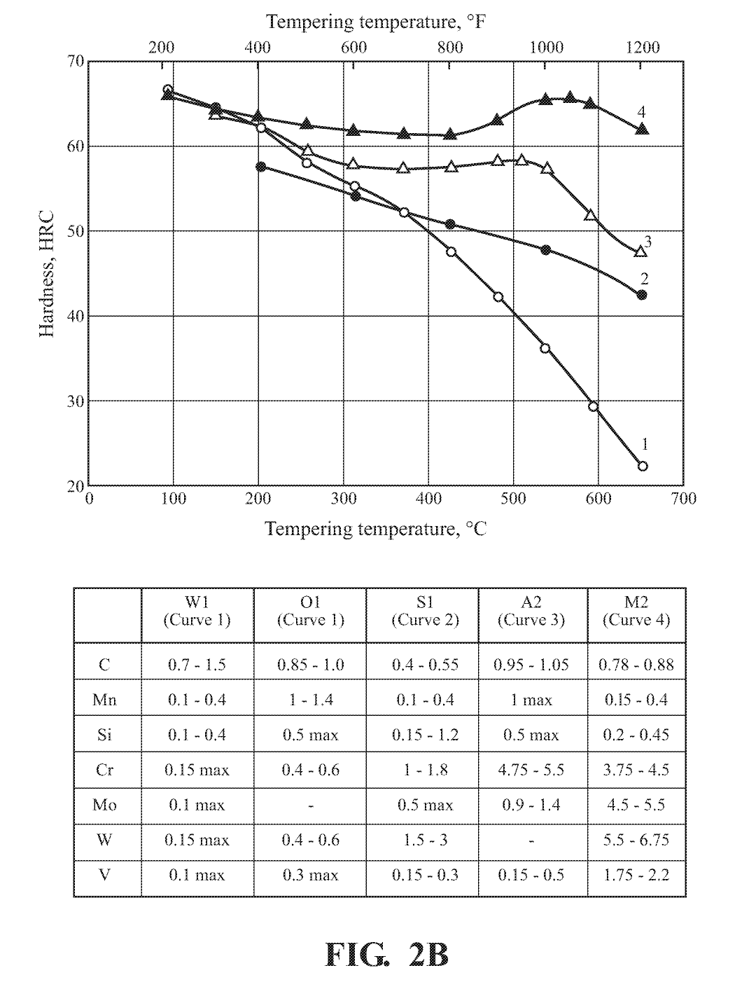

Some particular characteristics are preferred or required to obtain a thermometric powder metal material suitable for testing in the temperature range of 100° C. to 600° C., which is a typical range for the engine operating temperature. For example, the change in hardness relative to the change in temperature of the thermometric powder metal material is oftentimes important. FIG. 2A is an illustration of a change in hardness relative to change in tempering temperature of the thermometric powder metal material according to an embodiment of the invention (example A) and four comparative powder metal material (examples B-E). The curves of FIG. 2A are theoretical and illustrate the concept of suitable and unsuitable tempering curves. The thermometric powder metal material of example A has a uniform decrease in hardness as a function of temperature; and a D Hardness/D Temperature=>0.5 HV/° C. in the region of interest for the application, which is suitable for testing of engine operating conditions. In example B, secondary hardening of the powder metal material causes an inconsistent hardness reduction, which is not ideal for the testing. The powder metal material of example C also has an inconsistent hardness reduction which is not ideal for testing. In example D, the drop in hardness of the powder metal material is not large enough (<0.5 HV/° C.), leading to an unreliable temperature estimation. The powder metal material of example E has an inconsistent hardness reduction in some temperature ranges in the region of interest, also leading to an unreliable temperature estimation.

FIG. 2B illustrates a variation in hardness with tempering temperature for comparative materials, specifically typical tool steels referred to as W1, O1, S1, A2, and M2. The tempering curves of FIG. 2B are obtained from literature and show different tempering behavior. The curves are for 1 hour at each marked temperature. Tempering curve 1 corresponds to the W1 and O1 materials. The tempering curve 1 illustrates low resistance to softening as tempering temperatures increase, such as is exhibited by group W and group O tool steels. Tempering curve 2 corresponds to the S1 material. The tempering curve 2 illustrates medium resistance to softening, such as is exhibited by S1 tool steel. Tempering curve 3 corresponds to the A2 material, and tempering curve 4 corresponds to the M2 material. Tempering curves 3 and 4 illustrate high and very high resistance to softening, respectively, such as exhibited by the secondary hardening tool steels A2 and M2. Tempering curves 1, 3, and 4 are especially unsuitable for thermometric materials. Tempering curve 2 may be suitable as a wrought thermometric material.

As indicated above, various compositions can be used to form the thermometric powder metal material. Also as discussed above, the thermal conductivity of the thermometric powder metal material can be adjusted by controlling the porosity and/or by infiltrating the pores with copper. According to one embodiment, when the material is not infiltrated with copper, the porosity ranges from 80% up to 95% of the theoretical density of the thermometric powder metal material, and the typical density is from 6.2 up to 7.4 g/cm³. In this case, the thermal conductivity of the thermometric powder metal material is from 15 to 40 W/mK. According to another embodiment, the thermometric powder metal material is infiltrated with copper. The typical copper content is from 10% to 50% of the total mass of the thermometric powder metal material, and the typical density is 7.2 to 8.4 g/cm³. In this case, the thermal conductivity of the thermometric powder metal material is from 10 to 100 W/mK, or 25 to 80 W/mK. The thermal conductivity could be up to 100 W/mK if the mass of the thermometric powder metal material includes 50% copper. The thermal conductivity of the thermometric powder metal can vary significantly as a function of temperature.

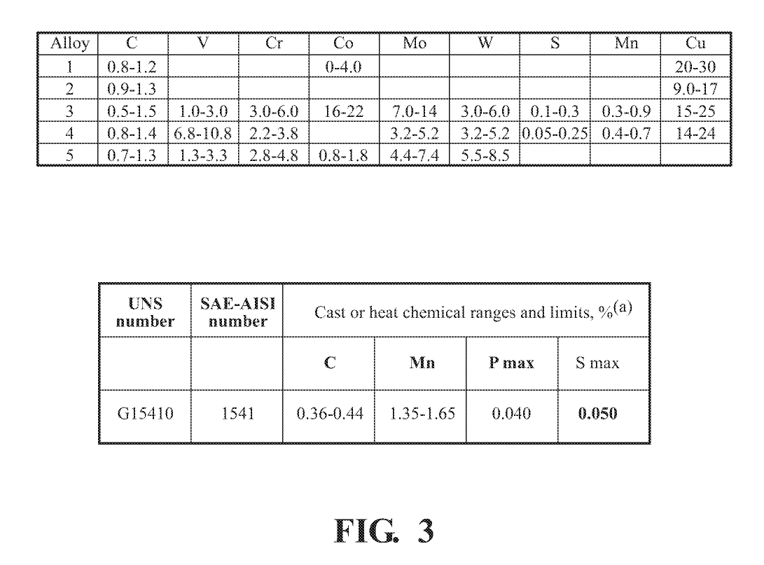

FIG. 3 includes a chart providing compositions of five standard powder metal materials that can be used in valve seat inserts or valve guides. The compositions of examples 1-5 of FIG. 3 are not the same as the compositions of examples A-E of FIG. 2. FIG. 3 also includes an example of a standard wrought thermometric material, specifically AISI 1541 steel. The remainder of each example composition of FIG. 3 is formed of iron and possible impurities. The values of the compositions of FIG. 3 are in weight percent (wt. %), based on the total weight of the material, also referred to as a mix or alloy.

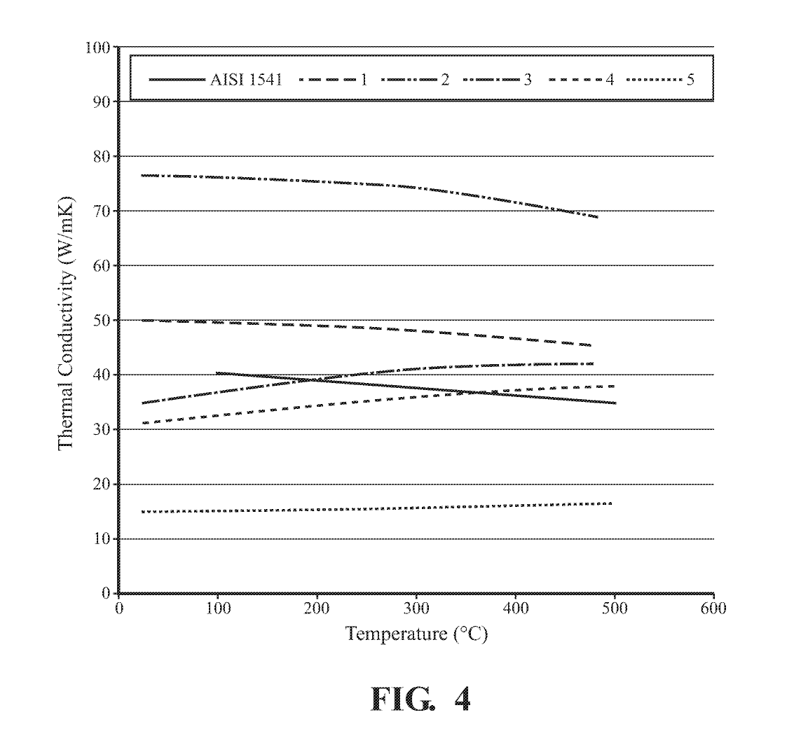

Since example materials 1-5 are powder metals, the thermal conductivity of those materials can increase or decrease as a function of temperature, as shown in FIG. 4. The curves of FIG. 4 illustrate the disparity of the thermal conductivity between the standard wrought thermometric material (AISI 1541) and the standard valve seat insert or valve guide powder metal materials (examples 1-5). Example materials 1 and 2 are low alloy steels infiltrated with copper for use in a valve seat insert. The thermal conductivity of example materials 1 and 2 decreases as a function of temperature. Example materials 3 and 4 are highly alloyed steels infiltrated with copper for use in a valve seat insert. The thermal conductivity of example materials 3 and 4 increases as a function of temperature. Example material 5 is a porous highly alloyed steel which is not infiltrated with copper for use in a valve seat insert. The thermal conductivity of example material 5 is relatively stable as a function of temperature. Because of the porous nature of the powder metal materials, it is not possible to quench the powder metal materials in a liquid, as the liquid can penetrate the pores and affect the thermal conductivity and thermo-physical behavior of the material. A standard method of heating the powder metal materials in order to burn the oil would affect the sensibility of the material to temperature estimation. Water quenching is too aggressive and would cause significant distortion or cracking of delicate thin wall parts, like valve seat inserts or valve guides.

As shown in FIG. 3, AISI 1541 steel is a comparative thermometric material, but this material is a wrought material rather than a powder metal. The thermal conductivity of the AISI 1541 steel and other wrought materials decreases with temperature, similarly to EN19T alloy steel, as shown in FIG. 4. For wrought materials, the procedure to obtain an appropriate microstructure (ex. EN19T) is to austenitize the material followed by oil quenching to achieved the desired martensitic microstructure. Also, traditional wrought materials (ex. EN19T) cannot be fully hardened using the standard powder metal sintering process used for the valve seat insert and valve guide sintering cycle. The thermometric powder metal materials should be more alloyed than the wrought materials. The thermometric powder metal materials are designed to be fully hardenable without using a liquid quench media. The thermometric powder metal materials are also designed to show tempering behavior similar to the example material A, as shown in FIG. 2, in order to be suitable for thermometric applications.

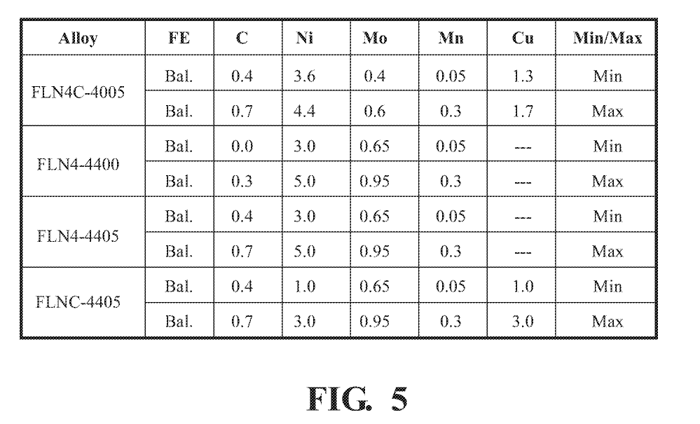

Other example materials that can be used as the thermometric powder metal material of the present invention are shown in FIG. 5, including FLN4C-4005, FLN4-4400, FLN4-4405, and FLNC-4405.

According to one embodiment, the thermometric powder metal material includes 0.4 to 0.7 wt. % carbon, 3.6 to 4.4 wt. % nickel, 0.4 to 0.6 wt. % molybdenum, 0.05 to 0.3 wt. % manganese, 1.3 to 1.7 wt. % copper, and a balance of iron and possible impurities, based on the total weight of the powder metal material.

According to another embodiment, the thermometric powder metal material includes up to 0.3 wt. % carbon, 3.0 to 5.0 wt. % nickel, 0.65 to 0.95 wt. % molybdenum, 0.05 to 0.3 wt. % manganese, and a balance of iron and possible impurities, based on the total weight of the powder metal material.

According to another embodiment, the thermometric powder metal material includes 0.4 to 0.7 wt. % carbon, 3.0 to 5.0 wt. % nickel, 0.65 to 0.95 wt. % molybdenum, 0.05 to 0.3 wt. % manganese, and a balance of iron and possible impurities, based on the total weight of the powder metal material.

According to another embodiment, the thermometric powder metal material includes 0.4 to 0.7 wt. % carbon, 1.0 to 3.0 wt. % nickel, 0.65 to 0.95 wt. % molybdenum, 0.05 to 0.3 wt. % manganese, 1.0 to 3.0 wt. % copper, and a balance of iron and possible impurities, based on the total weight of the powder metal material.

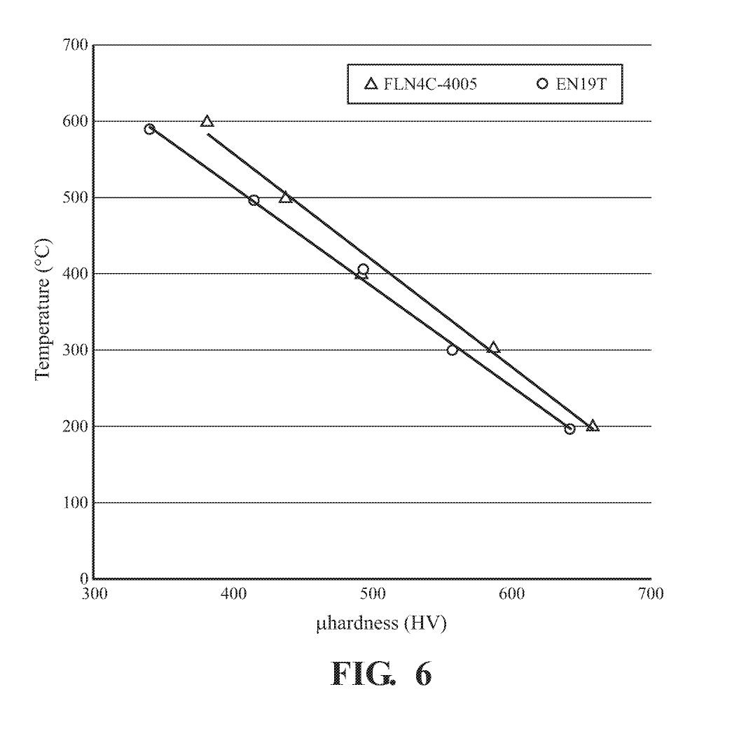

FIG. 6 illustrates a change in hardness relative to change in temperature for one of the example thermometric powder metal material compositions of FIG. 5, specifically FLN4C-4005, and a comparative wrought material, specifically EN19T.

Another aspect of the invention provides a method of manufacturing the thermometric powder metal material for testing, which replicates the actual powder metal material during use in the internal combustion engine. According to one embodiment, the method includes adjusting the thermal conductivity of the thermometric powder metal material by controlling the porosity of the material. According to another embodiment, in addition to or instead of controlling the porosity, the method includes adjusting the thermal conductivity of the thermometric powder metal material by infiltrating the pores of the material with copper.

The processing of the example thermometric powder metal materials for use in thermometric applications is typical of most of powder metal steels. The powder is first pressed to a specific density as a function of the desired final thermal conductivity. The process next includes sintering the pressed material, for example at 1120 C for 30 min in a 75% N₂/25% H₂ atmosphere. In the case of copper infiltrated materials, the sintering can be conducted during the infiltrating step. Next, the sintered material is cooled. The cooling rate should be fast enough to obtain a martensitic structure, for example 5 C/second. After sintering, the material can be tempered, for example for 1 hour at 100 C. To test the thermometric powder metal material, after sintering, a tempering curve is built, for example as shown in FIG. 2, for a predefined time, for example 2 hours. Samples of the sintered material are tempered at different temperatures and the microhardness is measured to obtain a curve of hardness as a function of temperature.

Another aspect of the invention provides a method of testing the thermometric powder metal material to estimate the thermal conductivity and temperature of the actual powder metal material during use of the actual material in the internal combustion engine. The method typically includes controlling the porosity and/or infiltrating the test thermometric powder metal material with copper prior to testing, so that the thermal conductivity of the test material simulates the thermal conductivity of the actual powder metal material which will be produced during use of the material in the internal combustion engine.

Another aspect of the invention provides estimating the properties of the actual powder metal material when the actual powder metal is used in an internal combustion engine using the thermometric powder metal material by adjusting the thermal conductivity of the thermometric powder metal material. For example, the method can first include adjusting or controlling the porosity of the thermometric powder metal material, and/or infiltrating pores of the thermometric powder metal material with copper. The method further includes subjecting the thermometric powder metal material to an engine test, and measuring the properties of the thermometric powder metal material during and/or after the engine test. The method then includes estimating the properties of the actual powder metal material when the actual powder metal material is used in an internal combustion engine based on the measured properties of the thermometric powder metal material tested. For example, to estimate the properties of the actual powder metal material, the method can include measuring the temperature of the thermometric powder metal material during and/or after the engine test, and/or measuring the thermal conductivity of the thermometric powder metal material during and/or after the engine test.

According to one embodiment, the method includes measuring microhardness of the thermometric powder metal material during and/or after the engine test, preparing tempering curves of the thermometric powder metal material, and using the tempering curves to estimate the temperature of the actual powder metal material when the actual powder metal material is used in an internal combustion engine based on the microhardness. In addition, a map of a temperature gradient of the actual powder metal material can be created.

According to another example embodiment, the thermometric powder metal material is used to estimate the temperature of the actual powder metal material during use of the actual material in a valve seat insert of an internal combustion engine. In this case, samples of the thermometric powder metal material are installed and prepared like a standard valve seat insert would be prepared. The engine is then run for a predefined amount of time similar to the time used to obtain the tempering curve, for example 2 hours. After testing, the samples of the thermometric powder metal material are disassembled and cross sections are mounted in order to carry-out microhardness measurements. As indicated above, the microhardness of the thermometric powder metal material is then measured in the areas where the temperature needs to be estimated. Tempering curves of the samples of the thermometric powder metal material are created, and the tempering curves are used to estimate the temperature based on the microhardness, therefore creating a map of the temperature gradient in the valve seat insert application. The same or similar procedure can also be used to estimate the temperatures of the actual powder metal materials used in other engine applications.

Obviously, many modifications and variations of the present invention are possible in light of the above teachings and may be practiced otherwise than as specifically described while within the scope of the invention. It is contemplated that all features described and all embodiments can be combined with each other, so long as such combinations would not contradict one another.

1. A thermometric powder metal material for testing to replicate an actual powder material during use of the actual powder metal material in an internal combustion engine, the thermometric powder metal material including pores and decreasing in hardness as a function of temperature according to the following equation: D Hardness/D Temperature=>0.5 HV/° C.

2. The thermometric powder metal material of claim 1, wherein the pores of the thermometric powder metal material are infiltrated with copper.

3. The thermometric powder metal material of claim 2, wherein the thermometric powder metal material includes the copper in an amount of from 10 to 50 wt. %, based on the total weight of the thermometric powder metal material.

4. The thermometric powder metal material of claim 3, wherein the density of the thermometric powder metal material is from 7.2 to 8.4 g/cm³.

5. The thermometric powder metal material of claim 4, wherein the thermometric powder metal material has a thermal conductivity of 10 to 100 W/mK or 25 to 80 W/mK.

6. The thermometric powder metal material of claim 1, wherein the thermometric powder metal material has a uniform decrease in hardness as a function of temperature.

7. The thermometric powder metal material of claim 1, wherein the thermometric powder metal material has a porosity ranging from 80% to 95% of the theoretical density of the thermometric powder metal material.

8. The thermometric powder metal material of claim 1, wherein the thermometric powder metal material has a density of 6.2 to 7.4 g/cm³.

9. The thermometric powder metal material of claim 8, wherein the thermometric powder metal material has a thermal conductivity of 15 to 40 W/mK.

10. The thermometric powder metal material of claim 1, wherein the thermometric powder metal material replicates a powder metal material used to form a component of a valve seat application.

11. The thermometric powder metal material of claim 1, wherein the thermometric powder metal material includes 0.4 to 0.7 wt. % carbon, 3.6 to 4.4 wt. % nickel, 0.4 to 0.6 wt. % molybdenum, 0.05 to 0.3 wt. % manganese, 1.3 to 1.7 wt. % copper, and a balance of iron and possible impurities, based on the total weight of the powder metal material.

12. The thermometric powder metal material of claim 1, wherein the thermometric powder metal material includes up to 0.3 wt. % carbon, 3.0 to 5.0 wt. % nickel, 0.65 to 0.95 wt. % molybdenum, 0.05 to 0.3 wt. % manganese, and a balance of iron and possible impurities, based on the total weight of the powder metal material.

13. The thermometric powder metal material of claim 1, wherein the thermometric powder metal material includes 0.4 to 0.7 wt. % carbon, 3.0 to 5.0 wt. % nickel, 0.65 to 0.95 wt. % molybdenum, 0.05 to 0.3 wt. % manganese, and a balance of iron and possible impurities, based on the total weight of the powder metal material.

14. The thermometric powder metal material of claim 1, wherein the thermometric powder metal material includes 0.4 to 0.7 wt. % carbon, 1.0 to 3.0 wt. % nickel, 0.65 to 0.95 wt. % molybdenum, 0.05 to 0.3 wt. % manganese, 1.0 to 3.0 wt. % copper, and a balance of iron and possible impurities, based on the total weight of the powder metal material.

15. A method of manufacturing a thermometric powder metal material for testing which replicates an actual powder metal material during use of the actual powder metal material in an internal combustion engine, comprising the steps of: adjusting or controlling the thermal conductivity of the thermometric powder metal material.

16. The method of claim 15 including adjusting or controlling the thermal conductivity by adjusting or controlling the porosity of the thermometric powder metal material.

17. The method of claim 15 including adjusting or controlling the thermal conductivity by infiltrating pores of the thermometric powder metal material with copper.

18. A method of estimating properties of an actual powder metal material when the actual powder metal is used in an internal combustion engine using a thermometric powder metal material, comprising the steps of: adjusting or controlling the thermal conductivity of the thermometric powder metal material.

19. The method of claim 18 including adjusting or controlling the thermal conductivity by adjusting or controlling the porosity of the thermometric powder metal material.

20. The method of claim 18 including adjusting or controlling the thermal conductivity by infiltrating pores of the thermometric powder metal material with copper.

21. The method of claim 18 including subjecting the thermometric powder metal material to an engine test, measuring the properties of the thermometric powder metal material during and/or after the engine test, and estimating the properties of the actual powder metal material when the actual powder metal material is used in an internal combustion engine based on the measured properties of the thermometric powder metal material tested.

22. The method of claim 21 including measuring the temperature of the thermometric powder metal material during and/or after the engine test.

23. The method of claim 21 including measuring the thermal conductivity of the thermometric powder metal material during and/or after the engine test.

24. The method of claim 21 including measuring microhardness of the thermometric powder metal material during and/or after the engine test, preparing tempering curves of the thermometric powder metal material, and using the tempering curves to estimate the temperature of the actual powder metal material when the actual powder metal material is used in an internal combustion engine based on the microhardness.

25. The method of claim 21 including creating a map of a temperature gradient of the actual powder metal material.
